(19) United States
(12) Patent Application Publication
(10) Pub. No.: US 2026/0259108 A1
(43) Pub. Date: Sep. 3, 2026

(54) METHOD FOR DETECTING FERRULE OF OPTICAL FIBER, SYSTEM FOR DETECTING FERRULE OF OPTICAL FIBER, STORAGE MEDIA, AND ELECTRONIC DEVICE

(71) Applicant: WuHan Raycus Fiber Laser Technologies CO., LTD, Wuhan, Hubei (CN)

(72) Inventors: Chong WANG, Wuhan, Hubei (CN); Mengdi WU, Wuhan, Hubei (CN); Jian SONG, Wuhan, Hubei (CN); Wenjuan WANG, Wuhan, Hubei (CN); Dapeng YAN, Wuhan, Hubei (CN)

(73) Assignee: WuHan Raycus Fiber Laser Technologies CO., LTD, Wuhan, Hubei (CN)

(21) Appl. No.: 18/879,871

(22) PCT Filed: May 20, 2024
(86) PCT No.: PCT/CN2024/094250

§ 371 Date: Dec. 30, 2024

(30) Foreign Application Priority Data
Jul. 10, 2023 (CN) 202310838005.0

(51) Int. Cl. G01M 11/00; G02B 6/38

(52) U.S. Cl. CPC G01M 11/33; G02B 6/385

(57) ABSTRACT

A method for detecting a ferrule of optical fiber, a system for detecting a ferrule of optical fiber, a storage medium and an electronic device are disclosed. The method includes: controlling a laser generator to emit a laser beam with a preset power, and the laser beam is focused on an end face of the ferrule of optical fiber to be detected and passes into the ferrule of optical fiber to be detected; obtaining real-time brightness at one or more preset positions of the ferrule of optical fiber to be detected, the one or more preset positions at least include a position at an adhesive tail of the ferrule of optical fiber to be detected; receiving the real-time brightness, and determining whether the ferrule of optical fiber to be detected is qualified based on the real-time brightness.

This application claims priority to and the benefit of Chinese Patent Application No. 202310838005.0, filed on Jul. 10, 2023, the disclosure of which is incorporated herein by reference in its entirety.

### TECHNICAL FIELD

The present disclosure belongs to the field of laser detecting technology, and in particular relates to a method for detecting a ferrule of optical fiber, a system for detecting a ferrule of optical fiber, a storage medium, and an electronic device.

### BACKGROUND

In semiconductor packaging, the ferrule of optical fiber structure is generally used. The optical fiber and the ceramic ferrule are fixed by using the epoxy resin, and then the integral ferrule of optical fiber is coupled and packaged with the light source. In the production and manufacturing of devices, it is necessary to detect the components used to ensure the qualification of the materials.

In related technologies, only optical fibers are detected, but defects in the ferrule of optical fiber cannot be completely detected, and the accuracy of the detecting results is low.

### SUMMARY

Embodiments of the present disclosure provide a method for detection a ferrule of optical fiber, a system for detection a ferrule of optical fiber, a storage media, and an electronic device to solve the existing problem that the accuracy of detecting results of defects in the ferrule of optical fiber is low.

In a first aspect, some embodiments of the present disclosure provide a method for detecting a ferrule of optical fiber, including:
controlling a laser generator to emit a laser beam with a preset power, the laser beam is focused on an end face of the ferrule of optical fiber to be detected and passes into the ferrule of optical fiber to be detected;
obtaining real-time brightness at one or more preset positions of the ferrule of optical fiber to be detected, and the one or more preset positions at least includes a position at an adhesive tail of the ferrule of optical fiber to be detected; and
receiving the real-time brightness, and determining whether the ferrule of optical fiber to be detected is qualified based on the real-time brightness.

In a second aspect, some embodiments of the present disclosure further provide a system for detecting a ferrule of optical fiber, including:
a laser generating module configured to control a laser generator to emit a laser beam with a preset power, the laser beam is focused on an end face of the ferrule of optical fiber to be detected and passes into the ferrule of optical fiber to be detected;
a brightness collecting module configured to obtain real-time brightness at one or more preset positions of the ferrule of optical fiber to be detected, and the one or more preset positions at least includes a position at an adhesive tail of the ferrule of optical fiber to be detected; and
a defect determining module of the ferrule of optical fiber connected to the brightness collecting module, and the defect determining module of the ferrule of optical fiber is configured to receive the real-time brightness and determine whether the ferrule of optical fiber to be detected is qualified according to the real-time brightness.

In a third aspect, some embodiments of the present disclosure further provide a storage medium on which a computer program is stored, when the computer program is executed by a processor, the processor implements any of the method for detecting a ferrule of optical fiber described above.

In a fourth aspect, some embodiments of the present disclosure further provide an electronic device, including:
one or at least one processor; and
a storage device configured to store one or at least one program;
when the one or at least one program is executed by the one or at least one processor, the one or at least one processor implements any one of the method for detecting a ferrule of optical fiber described above.

### Beneficial Effects

The beneficial effects of the present disclosure are that: in the method for detecting a ferrule of optical fiber, the system for detecting a ferrule of optical fiber, the storage medium and the electronic device provided by the embodiments of the present disclosure, by controlling the laser generator to emit a laser beam with a preset power, the laser beam is focused on the end face of the ferrule of optical fiber to be detected and passes into the ferrule of optical fiber to be detected, so that a light transmitting test is performed on the ferrule of optical fiber to be detected. Based on the real-time brightness at the preset position of the ferrule of optical fiber to be detected, whether the ferrule to be detected is qualified is determined, so as to overcome the existing problem that the accuracy of detecting results of defects in the ferrule of optical fiber is low, thereby accurately detecting defects in the ferrule of optical fiber caused by various reasons, and the accuracy of the detecting results is high.

### BRIEF DESCRIPTION OF THE DRAWINGS

In order to explain the technical solutions in the embodiments of the present disclosure more clearly, the accompanying drawings used in the description of the embodiments will be briefly introduced below. It is apparent that the accompanying drawings in the following description are only some embodiments of the present disclosure. For those skilled in the art, other accompanying drawings can be obtained based on these drawings without making creative efforts.

In order to have a more complete understanding of the present disclosure and its beneficial effects, the description will be made in combination with the accompanying drawings below. The same reference numerals represent the same portions in the following description.

FIG. 1 is a schematic diagram of a structure of a ferrule of optical fiber according to some embodiments of the present disclosure.

FIG. 2 is a flow chart of a method for detecting a ferrule of optical fiber according to some embodiments of the present disclosure.

FIG. 3 is a flow chart of specific steps of S30 in a method for detecting a ferrule of optical fiber according to some embodiments of the present disclosure.

FIG. 4 is a flow chart of a method for detecting a ferrule of optical fiber further having a step S40 according to some embodiments of the present disclosure.

FIG. 5 is a flow chart of specific steps of S40 in a method for detecting a ferrule of optical fiber according to some embodiments of the present disclosure.

FIG. 6 is a block diagram of a system for detecting a ferrule of optical fiber according to some embodiments of the present disclosure.

FIG. 7 is a block diagram of a defect determining module of a ferrule of optical fiber in a system for detecting a ferrule of optical fiber according to some embodiments of the present disclosure.

### EXPLANATION OF REFERENCE NUMERALS

100. Laser generator;
200. Brightness collecting module;
300. Defect determining module of a ferrule of optical fiber; 310. Presetting unit;
320. Receiving unit; 330. Comparing unit;
400. Ferrule of optical fiber; 410. Ferrule; 420. Metal handle; 430. Optical fiber sleeve; 440. Optical fiber;
500. Determining module;
600. Detection report generating module.

### DETAILED DESCRIPTION

The technical solutions in the embodiments of the present disclosure will be clearly and completely described below with reference to the accompanying drawings in the embodiments of the present disclosure. It is apparent that the described embodiments are only some of the embodiments of the present disclosure, rather than all of the embodiments of the embodiments of the present disclosure. Based on the embodiments of the present disclosure, all other embodiments obtained by those skilled in the art without making creative efforts fall within the scope of protection of the present disclosure.

Embodiments of the present disclosure provide a device to detect the ferrule of optical fiber to solve the existing problem that the accuracy of defecting results of defects in the ferrule of optical fiber is low. The following will be described with reference to the accompanying drawings.

Referring to FIG. 1, FIG. 1 is a schematic diagram of a structure of a ferrule of optical fiber according to some embodiments of the present disclosure.

The ferrule of optical fiber 400 includes a ferrule 410, a metal handle 420, an optical fiber sleeve 430 and an optical fiber 440. The optical fiber sleeve 430 is sleeved on the optical fiber 440, the ferrule 410 is sleeved on the optical fiber sleeve 430, and the metal handle 420 is sleeved on the ferrule 410. Adhesive is cured at the stripping port of the optical fiber, between the optical fiber 440 and the optical fiber sleeve 430, and between the optical fiber sleeve 430 and the metal handle 420.

Before the preparation of the laser diode, the ferrule of optical fiber is generally detected by a laser pen. Even if the detecting results of the ferrule of optical fibers are qualified, it is found that a large number of the prepared laser diodes are still unqualified. After research, it is found that the laser pen can only detect defects in the optical fiber 440 of the ferrule of optical fiber, but it can cannot detect structural defects at the stripping port of the optical fiber, between the optical fiber 440 and the optical fiber sleeve 430, and the installation position between the optical fiber sleeve 430 and the metal handle 420. Moreover, the adhesive is cured inside the ferrule and the metal handle and cannot be observed with the naked eye or microscope.

In the system for detecting a ferrule of optical fiber provided by the embodiments of the present disclosure, the laser generator is used to emit a laser beam with a preset power, so that a light transmitting test is performed on the ferrule of optical fiber to be detected. Based on the real-time brightness of the ferrule of optical fiber to be detected, whether the ferrule to be detected is qualified is determined, so as to overcome the existing problem that the accuracy of detecting results of defects in the ferrule of optical fiber is low, thereby accurately detecting defects in the ferrule of optical fiber caused by various reasons, and the accuracy of the detecting results is high.

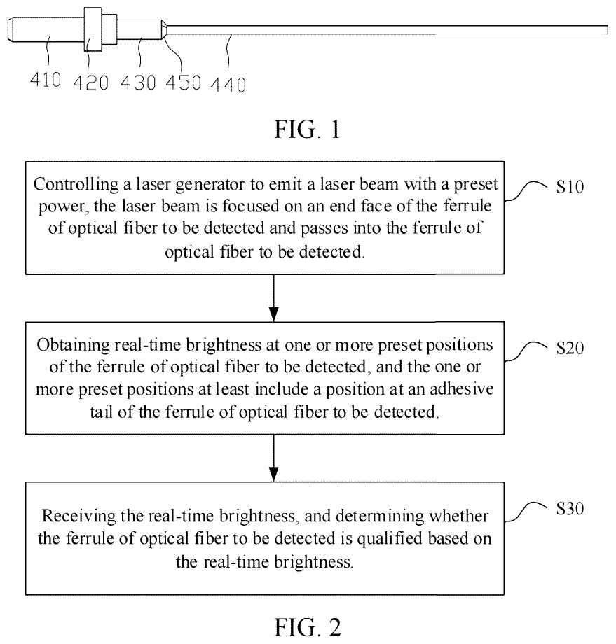

Referring to FIG. 2, FIG. 2 is a flow chart of a method for detecting a ferrule of optical fiber according to some embodiments of the present disclosure.

Some embodiments of the present disclosure provide a method for detecting a ferrule of optical fiber, including:

S10, controlling a laser generator to emit a laser beam with a preset power, the laser beam is focused on an end face of the ferrule of optical fiber to be detected and passes into the ferrule of optical fiber to be detected.

S20, obtaining real-time brightness at one or more preset positions of the ferrule of optical fiber to be detected, and the one or more preset positions at least include a position at an adhesive tail of the ferrule of optical fiber to be detected.

S30, receiving the real-time brightness, and determining whether the ferrule of optical fiber to be detected is qualified based on the real-time brightness.

The laser generator described above emits a laser beam with a preset power, and the laser beam is focused on the end face of the ferrule of optical fiber to be detected through a focusing lens. The preset power of the laser beam is above 100 mW. By controlling the preset power and focusing position of the laser beam, it is ensured that the laser beam can be emitted into the cladding of the ferrule of optical fiber to be detected, and can be luminous at the preset position when a failure occurs at the preset position, thereby detecting various failures of the ferrule of optical fiber and achieving light transmitting test of the ferrule of optical fiber to be detected, and improving the accuracy of the detecting results. In addition, visible light can be used for the laser beam, such as a red beam. The wavelength band of the laser beam is between 400 nm and 700 nm, which can be intuitively detected whether the preset position is luminous.

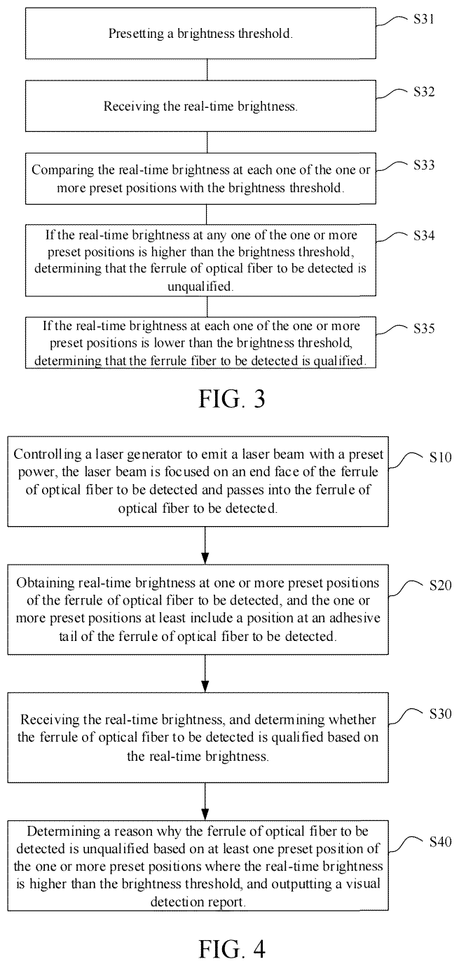

Referring to FIG. 3, FIG. 3 is a flow chart of specific steps of S30 in a method for detecting a ferrule of optical fiber according to some embodiments of the present disclosure.

In some embodiments, S30, receiving the real-time brightness, and determining whether the ferrule of optical fiber to be detected is qualified based on the real-time brightness includes the following operations.

S31, presetting a brightness threshold.

S32, receiving the real-time brightness.

S33, comparing the real-time brightness at each one of the one or more preset positions with the brightness threshold.

S34, if the real-time brightness at any one of the one or more preset positions is higher than the brightness threshold, determining that the ferrule of optical fiber to be detected is unqualified.

S35, if the real-time brightness at each one of the one or more preset positions is lower than the brightness threshold, determining that the ferrule fiber to be detected is qualified.

From the above, it can be seen that the one or more preset positions can only include the adhesive tail of the ferrule of optical fiber to be detected. When the real-time brightness at the preset position is higher than the brightness threshold, it can be concluded that the ferrule of optical fiber is unqualified. When the one or more preset positions include multiple positions, for example, including the adhesive tail of the ferrule of optical fiber to be detected and one or more positions on the optical fiber of the ferrule of optical fiber to be detected, which correspond to the first preset position and the second preset position, respectively. After the laser beam passes the ferrule of optical fiber, the real-time brightness at the first preset position and at the second preset position are respectively detected to obtain the first real-time brightness and the second real-time brightness. It is necessary to perform logical operation on the first real-time brightness and the second real-time brightness to perform a determination, so that the degree of automation is high, and the test results are more accurate.

The specific logical operation may be that: comparing the first real-time brightness and the second real-time brightness with the brightness threshold respectively. If any one or each one of the first real-time brightness and the second real-time brightness is higher than the brightness threshold, it is detected that the ferrule of optical fiber to be detected is unqualified. If each of the first real-time brightness and the second real-time brightness is lower than the brightness threshold, it is detected that the ferrule of optical fiber to be detected is qualified. As a variation, the first real-time brightness and the second real-time brightness can also be compared, and the larger one of the first real-time brightness and the second real-time brightness is compared with the brightness threshold. For example, if the second real-time brightness is greater than the first real-time brightness, then the second real-time brightness is compared with the brightness threshold. If the second real-time brightness is lower than the brightness threshold, it means that the ferrule of optical fiber to be detected is qualified. If the second real-time brightness exceeds the brightness threshold, it is detected that the ferrule of optical fiber to be detected is unqualified.

Referring to FIG. 4, FIG. 4 is a flow chart of a method for detecting a ferrule of optical fiber further having a step S40 according to some embodiments of the present disclosure.

In some embodiments, after S30: if the real-time brightness at any one of the one or more preset positions is higher than the brightness threshold, determining that the ferrule of optical fiber to be detected is unqualified, the method further includes following operation.

S40, determining a reason why the ferrule of optical fiber to be detected is unqualified based on at least one preset position of the one or more preset positions where the real-time brightness is higher than the brightness threshold, and outputting a visual detection report.

It can be understood that when the one or more preset positions include multiple preset positions, the reason why the ferrule of optical fiber to be detected is unqualified can be determined based on the preset position where the real-time brightness is higher than the brightness threshold, and the visual detection report can be output to visually display the reason why the ferrule of optical fiber to be detected is unqualified. A detection report can be provided for users to check, and the detection report can also be uploaded to the database to facilitate the user to trace the production process of the ferrule of optical fiber. In addition, the user can also classify the unqualified reasons based on the detection report and provide guidance to subsequent process for improvements.

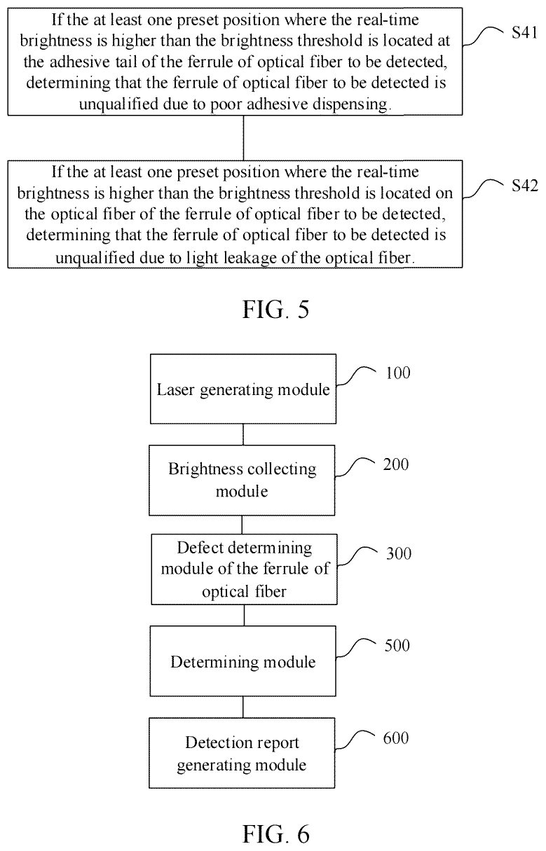

Referring to FIG. 5, FIG. 5 is a flow chart of specific steps of S40 in a method for detecting a ferrule of optical fiber according to some embodiments of the present disclosure.

In some embodiments, S40, determining the reason why the ferrule of optical fiber to be detected is unqualified based on the at least one preset position, includes the following operations.

S41, if the at least one preset position where the real-time brightness is higher than the brightness threshold is located at the adhesive tail of the ferrule of optical fiber to be detected, determining that the ferrule of optical fiber to be detected is unqualified due to poor adhesive dispensing.

S42, if the at least one preset position where the real-time brightness is higher than the brightness threshold is located on the optical fiber of the ferrule of optical fiber to be detected, determining that the ferrule of optical fiber to be detected is unqualified due to light leakage of the optical fiber.

When there are multiple preset positions and the detection of real-time brightness is performed for multiple positions, the specific position of the preset position where the real-time brightness is higher than the brightness threshold on the ferrule of optical fiber to be detected can also be used to further clarify whether the reason why the ferrule of optical fiber to be detected is unqualified is due to a defect of the optical fiber or a defect of the installation structure, so as to clarify the unqualified reasons, so that the detection is more comprehensive, the detecting results are more accurate, which can also be used to guide the subsequent production of the ferrule of optical fiber.

Referring to FIG. 6, FIG. 6 is a block diagram of a system for detecting a ferrule of optical fiber according to some embodiments of the present disclosure.

Some embodiments of the present disclosure further provide a system for detecting a ferrule of optical fiber, the system includes:
a laser generating module 100 configured to control a laser generator to emit a laser beam with a preset power, the laser beam is focused on an end face of the ferrule of optical fiber to be detected and passes into the ferrule of optical fiber to be detected;
a brightness collecting module 200 configured to obtain real-time brightness at one or more preset positions of the ferrule of optical fiber to be detected, and the one or more preset positions at least include a position at an adhesive tail of the ferrule of optical fiber to be detected; and
a defect determining module of the ferrule of optical fiber 300 connected to the brightness collecting module, and the defect determining module of the ferrule of optical fiber is configured to receive the real-time brightness and determine whether the ferrule of optical fiber to be detected is qualified according to the real-time brightness.

Through the system described above, the laser generator emits a laser beam with a preset power, the laser beam is focused on the end face of the ferrule of optical fiber to be detected through a focusing lens. The preset power of the laser beam is above 100 mW. By controlling the preset power and focusing position of the laser beam, it is ensured that the laser beam can be emitted into the cladding of the ferrule of optical fiber to be detected, and can be luminous at the preset position when a failure occurs at the preset position, thereby detecting various failures of the ferrule of optical fiber and achieving light transmitting test of the ferrule of optical fiber to be detected, and improving the accuracy of the detecting results. In addition, visible light can be selected for the laser beam, such as a red beam. The wavelength band of the laser beam is between 400 nm and 700 nm, which can be intuitively detected whether the preset position is luminous.

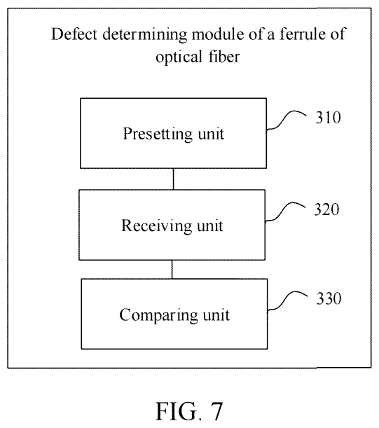

Referring to FIG. 7, FIG. 7 is a block diagram of a defect determining module of a ferrule of optical fiber in a system for detecting a ferrule of optical fiber according to some embodiments of the present disclosure.

Based on the above embodiments, the defect determining module of a ferrule of optical fiber 300 includes:
a presetting unit 310 configured to preset a brightness threshold;
a receiving unit 320 configured to receive real-time brightness; and
a comparing unit 330 configured to compare the real-time brightness with the brightness threshold, if the real-time brightness at any one of the one or more preset positions is higher than the brightness threshold, the comparing unit determines that the ferrule of optical fiber to be detected is unqualified, or if the real-time brightness at each of the one or more preset positions is lower than the brightness threshold, the comparing unit determines that the ferrule of optical fiber to be detected is qualified.

Based on the implementations described above, as shown in FIG. 6, the system further includes:
a determining module 500 configured to determine a reason why the ferrule of optical fiber to be detected is unqualified based on at least one preset position of the one or more preset positions where the real-time brightness is higher than the brightness threshold, if there are multiple preset positions and after the comparing unit determines that the ferrule of optical fiber to be detected is unqualified;
a detection report generating module 600 configured to generate a visual detection report.

Based on the implementations described above, the determining module 500 is configured to:
when the at least one preset position where the real-time brightness is higher than the brightness threshold is located at the adhesive tail of the ferrule of optical fiber to be detected, determine that the ferrule of optical fiber to be detected is unqualified due to poor adhesive dispensing; or
when the at least one preset position where the real-time brightness is higher than the brightness threshold is located on the optical fiber of the ferrule of optical fiber to be detected, determine that the ferrule of optical fiber to be detected is unqualified due to light leakage of the optical fiber.

It should be noted that each of the modules described above can be implemented through software or hardware. For the hardware, it can be implemented in the following manners, but it is not limited thereto: each of the modules described above is located in the same memory; or the modules described above can be located in different processors in any combination.

Some embodiments of the present disclosure further provide a storage medium on which a computer program is stored, when the computer program is executed by a processor, the processor implements any one of the methods described above.

In some embodiments of the present disclosure, the computer readable storage medium may be configured to store a computer program for performing the following operations.

S10: controlling a laser generator to emit a laser beam with a preset power, the laser beam is focused on an end face of the ferrule of optical fiber to be detected and passes into the ferrule of optical fiber to be detected.

S20: obtaining real-time brightness at one or more preset positions of the ferrule of optical fiber to be detected, and the one or more preset positions at least include a position at an adhesive tail of the ferrule of optical fiber to be detected.

S30: receiving the real-time brightness, and determining whether the ferrule of optical fiber to be detected is qualified based on the real-time brightness.

In some embodiments, the computer readable storage medium may include but is not limited to: universal serial bus (USB) flash disk, read-only memory (ROM), random access memory (RAM), mobile hard disk, magnetic disks or optical disks and other media that can store the computer program.

Some embodiments of the present disclosure further provide an electronic device, including:
one or at least one processor; and
a storage device configured to store one or at least one program;
when the one or at least one program is executed by the one or at least one processor, the one or at least one processor implements any one of the method for detecting a ferrule of optical fiber described above.

In the above embodiments, each embodiment is described with its own emphasis. For parts that are not described in detail in a certain embodiment, reference can be made to the relevant descriptions of other embodiments.

Some embodiments of the present disclosure further provide a storage medium on which a computer program is stored, when the computer program is executed by a processor, the processor implements any one of the methods described above.

In some embodiments of the present disclosure, the processor described above may be configured to store a computer program for performing the following operations.

S10: controlling a laser generator to emit a laser beam with a preset power, the laser beam is focused on an end face of the ferrule of optical fiber to be detected and passes into the ferrule of optical fiber to be detected.

S20: obtaining real-time brightness at one or more preset positions of the ferrule of optical fiber to be detected, and the one or more preset positions at least include a position at an adhesive tail of the ferrule of optical fiber to be detected.

S30: receiving the real-time brightness, and determining whether the ferrule of optical fiber to be detected is qualified based on the real-time brightness.

It is apparent that those skilled in the art should understand that the modules or steps of the present disclosure described above can be implemented by using a general computing device. The modules or steps can be integrated on a single computing device, or distributed across a network composed of multiple computing devices. The modules or steps may be implemented in program code executable by the computing device, so that the modules or steps may be stored in a storage device for execution by the computing device. In some cases, the steps shown or described may be executed in a sequence different from that shown herein. Or the modules or steps can be implemented by making them into individual integrated circuit modules respectively, or by making multiple ones of the modules or steps into a single integrated circuit module. Therefore, the present disclosure is not limited to any specific combination of hardware and software.

The above descriptions are only preferred embodiments of the present disclosure and are not intended to limit the present disclosure. For those skilled in the art, the present disclosure may have various modifications and changes. Any modifications, equivalent replacements, improvements, and the like made within the principles of the present disclosure shall be included in the scope of protection of the present disclosure.

1. A method for detecting a ferrule of optical fiber, wherein the ferrule of optical fiber comprises a metal handle and an optical fiber sleeve, an adhesive is cured between the optical fiber sleeve and the metal handle, and the method comprises:
controlling a laser generator to emit a laser beam with a preset power, wherein the laser beam is focused on an end face of the ferrule of optical fiber to be detected and passes into the ferrule of optical fiber to be detected;
obtaining real-time brightness at one or more preset positions of the ferrule of optical fiber to be detected, wherein the one or more preset positions at least comprises a position at an adhesive tail of the ferrule of optical fiber to be detected, and the adhesive tail is a bonding position between an end of the metal handle and the optical fiber sleeve; and
receiving the real-time brightness, and determining whether the ferrule of optical fiber to be detected is qualified based on the real-time brightness.

2. The method for detecting the ferrule of optical fiber according to claim 1, wherein receiving the real-time brightness, and determining whether the ferrule of optical fiber to be detected is qualified based on the real-time brightness comprises:
presetting a brightness threshold;
receiving the real-time brightness;
comparing the real-time brightness at each of the one or more preset positions with the brightness threshold; and
if the real-time brightness at any one of the one or more preset positions being higher than the brightness threshold, determining that the ferrule of optical fiber to be detected is unqualified.

3. The method for detecting the ferrule of optical fiber according to claim 2, wherein if the real-time brightness at any one of the one or more preset positions is higher than the brightness threshold, after determining that the ferrule of optical fiber to be detected is unqualified, the method further comprises:
determining a reason why the ferrule of optical fiber to be detected is unqualified based on at least one preset position of the one or more preset positions where the real-time brightness is higher than the brightness threshold; and
outputting a visual detection report.

4. The method for detecting the ferrule of optical fiber according to claim 3, wherein determining the reason why the ferrule of optical fiber to be detected is unqualified based on the at least one preset position of the one or more preset positions comprises:
if the at least one preset position where the real-time brightness is higher than the brightness threshold is located at the adhesive tail of the ferrule of optical fiber to be detected, determining that the ferrule of optical fiber to be detected is unqualified due to poor adhesive dispensing.

5. A system for detecting the ferrule of optical fiber, wherein the ferrule of optical fiber comprises a metal handle and an optical fiber sleeve, adhesive is cured between the optical fiber sleeve and the metal handle, and the system comprises:
a laser generating module configured to control a laser generator to emit a laser beam with a preset power, wherein the laser beam is focused on an end face of the ferrule of optical fiber to be detected and passes into the ferrule of optical fiber to be detected;
a brightness collecting module configured to obtain real-time brightness at one or more preset positions of the ferrule of optical fiber to be detected, wherein the one or more preset positions at least comprise a position at an adhesive tail of the ferrule of optical fiber to be detected, and the adhesive tail is a bonding position between an end of the metal handle and the optical fiber sleeve; and
a defect determining module of the ferrule of optical fiber connected to the brightness collecting module, wherein the defect determining module of the ferrule of optical fiber is configured to receive the real-time brightness and determine whether the ferrule of optical fiber to be detected is qualified according to the real-time brightness.

6. The system for detecting the ferrule of optical fiber according to claim 5, wherein the defect determining module of the ferrule of optical fiber comprises:
a presetting unit configured to preset a brightness threshold;
a receiving unit configured to receive the real-time brightness; and
a comparing unit configured to compare the real-time brightness with the brightness threshold, wherein if the real-time brightness at any one of the one or more preset positions is higher than the brightness threshold, the comparing unit determines that the ferrule of optical fiber to be detected is unqualified.

7. The system for detecting the ferrule of optical fiber according to claim 6, wherein the system further comprises:
a determining module configured to determine a reason why the ferrule of optical fiber to be detected is unqualified based on at least one preset position of the one or more preset positions where the real-time brightness is higher than the brightness threshold, after the comparing unit determines that the ferrule of optical fiber to be detected is unqualified; and
a detection report generating module configured to output a visual detection report.

8. The system for detecting the ferrule of optical fiber according to claim 7, wherein the determining module is further configured to:
when the at least one preset position where the real-time brightness is higher than the brightness threshold is located at the adhesive tail of the ferrule of optical fiber to be detected, determine that the ferrule of optical fiber to be detected is unqualified due to poor adhesive dispensing.

9. A storage medium, wherein a computer program is stored on the storage medium, when the computer program is executed by a processor, the processor implements the method for detecting a ferrule of optical fiber according to claim 1.

10. An electronic device comprising:
one or at least one processor; and
a storage device configured to store one or at least one program;
wherein when the one or at least one program is executed by the one or at least one processor, the one or at least one processor implements a method for detecting a ferrule of optical fiber, wherein the ferrule of optical fiber comprises a metal handle and an optical fiber sleeve, an adhesive is cured between the optical fiber sleeve and the metal handle, and the method comprises:
controlling a laser generator to emit a laser beam with a preset power, wherein the laser beam is focused on an end face of the ferrule of optical fiber to be detected and passes into the ferrule of optical fiber to be detected;
obtaining real-time brightness at one or more preset positions of the ferrule of optical fiber to be detected, the one or more preset positions at least comprises a position at an adhesive tail of the ferrule of optical fiber to be detected, and the adhesive tail is a bonding position between an end of the metal handle and the optical fiber sleeve; and
receiving the real-time brightness, and determining whether the ferrule of optical fiber to be detected is qualified based on the real-time brightness.

11. The electronic device according to claim 10, wherein receiving the real-time brightness, and determining whether the ferrule of optical fiber to be detected is qualified based on the real-time brightness comprises:
presetting a brightness threshold;
receiving the real-time brightness;
comparing the real-time brightness at each of the one or more preset positions with the brightness threshold; and
if the real-time brightness at any one of the one or more preset positions being higher than the brightness threshold, determining that the ferrule of optical fiber to be detected is unqualified.

12. The electronic device according to claim 10, wherein receiving the real-time brightness, and determining whether the ferrule of optical fiber to be detected is qualified based on the real-time brightness comprises:
presetting a brightness threshold;
receiving the real-time brightness;
comparing the real-time brightness at each of the one or more preset positions with the brightness threshold; and
if the real-time brightness at each of the one or more preset positions being lower than the brightness threshold, determining that the ferrule of optical fiber to be detected is qualified.

13. The electronic device according to claim 11, wherein if the real-time brightness at any of the one or more preset positions is higher than the brightness threshold, after determining that the ferrule of optical fiber to be detected is unqualified, the method further comprises:
determining a reason why the ferrule of optical fiber to be detected is unqualified based on at least one preset position of the one or more preset positions where the real-time brightness is higher than the brightness threshold; and
outputting a visual detection report.

14. The electronic device according to claim 13, wherein determining the reason why the ferrule of optical fiber to be detected is unqualified based on the at least one preset position of the one or more preset positions comprises:
if the at least one preset position where the real-time brightness is higher than the brightness threshold is located at the adhesive tail of the ferrule of optical fiber to be detected, determining that the ferrule of optical fiber to be detected is unqualified due to poor adhesive dispensing.

15. The electronic device according to claim 13, wherein determining the reason why the ferrule of optical fiber to be detected is unqualified based on the at least one preset position of the one or more preset positions comprises:
if the at least one preset position where the real-time brightness is higher than the brightness threshold is located on the optical fiber of the ferrule of optical fiber to be detected, determining that the ferrule of optical fiber to be detected is unqualified due to light leakage of the optical fiber.

16. The method for detecting the ferrule of optical fiber according to claim 1, wherein receiving the real-time brightness, and determining whether the ferrule of optical fiber to be detected is qualified based on the real-time brightness comprises:
presetting a brightness threshold;
receiving the real-time brightness;
comparing the real-time brightness at each of the one or more preset positions with the brightness threshold; and
if the real-time brightness at each of the one or more preset positions is lower than the brightness threshold, determining that the ferrule of optical fiber to be detected is qualified.

17. The method for detecting the ferrule of optical fiber according to claim 3, wherein determining the reason why the ferrule of optical fiber to be detected is unqualified based on the at least one preset position of the one or more preset positions comprises:
if the at least one preset position where the real-time brightness is higher than the brightness threshold is located on the optical fiber of the ferrule of optical fiber to be detected, determining that the ferrule of optical fiber to be detected is unqualified due to light leakage of the optical fiber.

18. The system for detecting the ferrule of optical fiber according to claim 5, wherein the defect determining module of the ferrule of optical fiber comprises:
a presetting unit configured to preset a brightness threshold;
a receiving unit configured to receive the real-time brightness; and
a comparing unit configured to compare the real-time brightness with the brightness threshold, if the real-time brightness at each of the one or more preset positions is lower than the brightness threshold, the comparing unit determines that the ferrule of optical fiber to be detected is qualified.

19. The system for detecting the ferrule of optical fiber according to claim 7, wherein the determining module is further configured to:
when the at least one preset position where the real-time brightness is higher than the brightness threshold is located on the optical fiber of the ferrule of optical fiber to be detected, determine that the ferrule of optical fiber to be detected is unqualified due to light leakage of the optical fiber.

20. The system for detecting the ferrule of optical fiber according to claim 5, wherein the preset power of the laser beam is above 100mW, and/or a wavelength band of the laser beam is between 400 nm and 700 nm.
